(19) United States
(12) Patent Application Publication
(10) Pub. No.: US 2023/0335761 A1
(43) Pub. Date: Oct. 19, 2023

(54) CLASS OF MODIFIED CATALYSTS, PROCESS FOR PREPARING THE MODIFIED CATALYSTS AND IMPLEMENTATION OF THE MODIFIED CATALYSTS TO BOOST ELECTROLYTE RETENTION IN PHOSPHORIC ACID FUEL CELLS

(71) Applicant: National Tsing Hua University, Hsinchu City (TW)

(72) Inventors: Fan-Gang Tseng, Hsinchu City (TW); Pen-Cheng Wang, Hsinchu City (TW); Yi-Lun Tsai, Hsinchu City (TW); Chin-Wei Chang, Hsinchu City (TW)

(73) Assignee: National Tsing Hua University, Hsinchu City (TW)

(21) Appl. No.: 18/299,075

(22) Filed: Apr. 12, 2023

(30) Foreign Application Priority Data
Apr. 13, 2022 (TW) 111113998

(51) Int. Cl. H01M 4/92; H01M 8/086; H01M 4/90

(52) U.S. Cl. CPC H01M 4/926; H01M 4/9083; H01M 4/92; H01M 8/086

(57) ABSTRACT

The art for the design of a class of modified catalysts, the process for preparing such modified catalysts and implementation of such modified catalysts in phosphoric acid fuel cells is disclosed. The modified catalyst comprises a particle of a metal-doped porous material and an amount of a phosphate-containing acid group or phosphate-containing acid groups. The particle of the metal-doped porous material is a particle of a porous carrier with metal microparticles and a plurality of hydroxyl groups on the surface of the porous carrier such that (i) the plurality of metal microparticles are attached to a first portion of the plurality of hydroxyl groups of the surface of the porous carrier and (ii) an amount of a phosphate-containing acid group or phosphate-containing acid groups can be bonded to a second portion of the plurality of hydroxyl groups of the surface of the porous carrier to form the modified catalyst.

### CROSS-REFERENCE TO RELATED APPLICATION

This application claims the priority benefit of Taiwan Application Serial No. 111113998, filed on Apr. 13, 2022. The entirety of the above-mentioned patent application is hereby incorporated by reference herein and made a part of this specification.

### BACKGROUND

### Technical Field

The disclosure relates to a phosphoric acid fuel cell technology, and particularly relates to a class of modified catalysts, a process for preparing the modified catalysts and implementation of the modified catalysts in phosphoric acid fuel cells, in which leakage of phosphoric acid can be reduced.

### Related Art

Fuel cells are currently one of the most popular energy solutions for the future. For example, phosphoric acid fuel cells have become a hot research topic in recent years due to their high efficiency and CO tolerance.

However, unlike polymer electrolyte membrane (PEM) fuel cells which use a solid-state ionomer membrane as an electrolyte, the phosphoric acid fuel cells use a phosphoric acid-doped porous medium as an electrolyte. Since the phosphoric acid is a liquid-state substance, leakage may occur during operation, and durability of the phosphoric acid fuel cells for long-term use may be reduced. Therefore, there is an urgent need for solutions to the aforementioned issue.

### SUMMARY

The disclosure provides the design of a class of modified catalysts of a phosphoric acid fuel cell, in which the modified catalysts can provide a proton conduction path while improving phosphoric acid adsorption capacity.

The disclosure further provides a phosphoric acid fuel cell in which electrolyte leakage can be reduced.

The disclosure also provides a process for preparing a class of modified catalysts of a phosphoric acid fuel cell, in which a modified catalyst having high phosphoric acid adsorption capacity can be prepared in a simple manner.

A modified catalyst of a phosphoric acid fuel cell according to the disclosure includes a particle of a metal-doped porous material and an amount of a phosphate-containing acid group or phosphate-containing acid groups. The particle of the metal-doped porous material is a particle of a porous carrier with metal microparticles and a plurality of hydroxyl groups on the surface of the porous carrier such that (i) the plurality of metal microparticles are attached to a first portion of the plurality of hydroxyl groups of the surface of the porous carrier and (ii) the phosphate-containing acid group or groups can be bonded to a second portion of the plurality of hydroxyl groups of the surface of the porous carrier to form the modified catalyst.

In one embodiment of the disclosure, the phosphate-containing acid group includes a phytic acid group, a phosphoric acid group or an inositol tetraphosphate group.

In one embodiment of the disclosure, the porous carrier includes activated carbon or carbon black.

In one embodiment of the disclosure, a material of the metal microparticles includes platinum, ruthenium, palladium, cobalt, iridium or nickel.

A phosphoric acid fuel cell according to the disclosure includes the modified catalyst as described above.

A process for preparing a modified catalyst of a phosphoric acid fuel cell according to the disclosure is described below. A substance that is a particle of a metal-doped porous material is provided as a catalyst. The particle is a particle of a porous carrier with metal microparticles and a plurality of hydroxyl groups on the surface of the porous carrier such that the plurality of metal microparticles are attached to a first portion of the plurality of hydroxyl groups of the surface of the porous carrier. The catalyst is then mixed with a phosphate-containing acid. Then, a second portion of the plurality of hydroxyl groups of the surface of the porous carrier is subjected to a chemical conjugation reaction with the phosphate-containing acid.

In another embodiment of the disclosure, the phosphate-containing acid includes phytic acid, phosphoric acid or inositol tetraphosphate.

In another embodiment of the disclosure, the catalyst includes a commercially available catalyst or a synthesized catalyst.

Based on the above, in the disclosure, the phosphate-containing acid group is bonded to the hydroxyl group of the surface of the catalyst through the chemical conjugation reaction. Since the phosphate-containing acid group has one or more phosphate groups, hydrophilicity of the catalyst layer for a fuel cell is improved and the effect of adsorbing phosphoric acid of the catalyst layer is enhanced as well. Also, the phosphate groups may serve as a proton conduction path.

Several exemplary embodiments accompanied with figures are described in detail below to further describe the disclosure in details.

### BRIEF DESCRIPTION OF THE DRAWINGS

FIG. 1 is a schematic diagram of a modified catalyst of a phosphoric acid fuel cell according to one embodiment of the disclosure.

FIG. 2 is a schematic diagram of an example of the modified catalyst of FIG. 1.

FIG. 3 is a flowchart of preparation of a modified catalyst of a phosphoric acid fuel cell according to another embodiment of the disclosure.

FIG. 4 is a bar graph showing daily changes in phosphoric acid leakage of fuel cells of an experimental example and a comparative example.

FIG. 5 is a graph of polarization curves and power densities of fuel cells of an experimental example and a comparative example.

### DESCRIPTION OF EMBODIMENTS

Exemplary embodiments of the disclosure will be described below with reference to the drawings, but the disclosure may be embodied in various different forms and should not be construed as being limited to the embodiments described below. In the drawings, for the sake of clarity, each composition, particle and group are illustrated schematically rather than in accordance with their actual sizes. To facilitate the understanding, the same elements in the following description are marked with the same reference numerals.

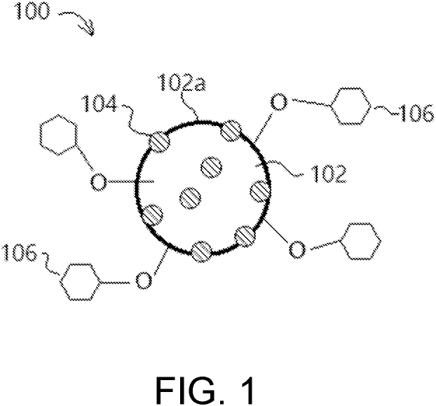

FIG. 1 is a schematic diagram of a modified catalyst of a phosphoric acid fuel cell according to one embodiment of the disclosure.

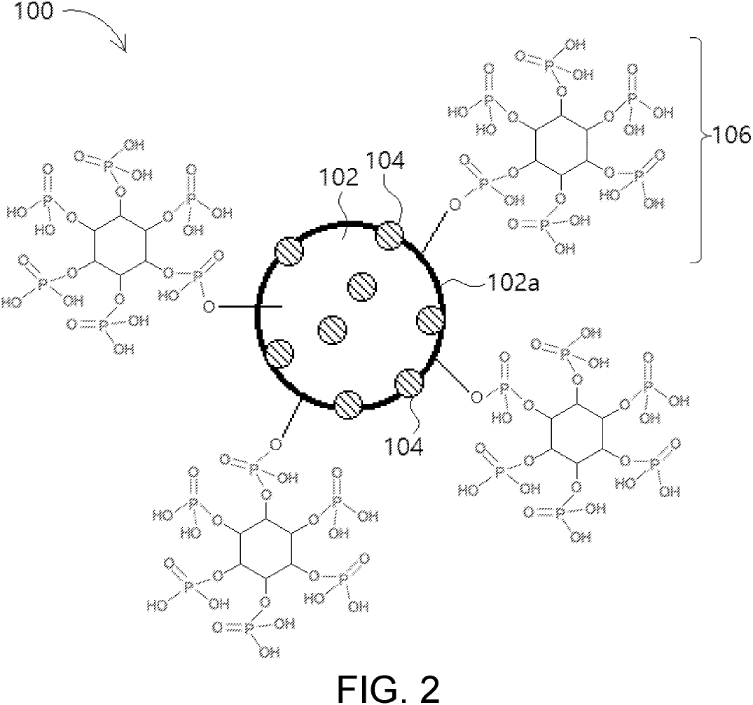

Referring to FIG. 1, a modified catalyst 100 of a phosphoric acid fuel cell of the present embodiment is a particle of a metal-doped porous material and is a particle of a porous carrier 102 with metal microparticles 104. The surface 102a of the porous carrier 102 has a plurality of hydroxyl groups, and the metal microparticles 104 are attached to a first portion of the hydroxyl groups (not shown) of the surface 102a of the porous carrier 102. The modified catalyst 100 further includes an amount of a phosphate-containing acid group or phosphate-containing acid groups 106. The phosphate-containing acid group 106 is bonded to a second portion of hydroxyl groups of the surface 102a of the porous carrier 102. The phosphate-containing acid group 106 refers to an acid group having one or more phosphate groups, preferably an acid group having multiple phosphate groups. In FIG. 1, the phosphate-containing acid group 106 is represented by a hexagon. However, it is to be understood that the drawing herein only indicates the position and inclusion of the group rather than limiting the phosphate-containing acid group to a carbocyclic ring containing six carbon atoms. Specific examples of the phosphate-containing acid group 106 include, but are not limited to, a phosphoric acid group, a phosphonic acid group, a phytic acid group, and an inositol tetraphosphate group. The porous carrier 102 is mostly a carbon-based material, including, but are not limited to, activated carbon, carbon black, fullerene, carbon nanotube, graphene and graphene oxide. The metal microparticles 104 are a main catalytic material, and examples thereof include, but are not limited to, platinum, ruthenium, palladium, cobalt, iridium, and nickel. In order to adhere the metal microparticles 104 to the porous carrier 102, generally, a large number of hydroxyl groups are first generated on the surface 102a of the porous carrier 102 by an etching process, and the hydroxyl groups are used for bonding the metal microparticles 104 to the porous carrier 102. Accordingly, the surface 102a of the porous carrier 102 may also include a portion of hydroxyl groups not bonded to any metal microparticles. Since the hydroxyl groups of the surface 102a of the porous carrier 102 may be subjected to a chemical conjugation reaction with a phosphate-containing acid, a bonded phosphate-containing acid group 106 can be formed on the surface 102a of the porous carrier 102. In FIG. 2, a phytic acid group serves as the phosphate-containing acid group 106. Phytic acid is an environmentally friendly substance extracted from a plant. Since the phytic acid has a molecular formula of a carbocyclic ring containing six carbon atoms with one phosphate group bonded to each or some of the six carbon atoms, the modified catalyst 100 may provide a large number of phosphate groups as a proton conduction path. Further, hydrophilicity of the catalyst layer for a phosphoric acid fuel cell can be improved, thereby enhancing the effect of adsorbing phosphoric acid. Thus, in the phosphoric acid fuel cell according to the disclosure, electrolyte leakage can be reduced.

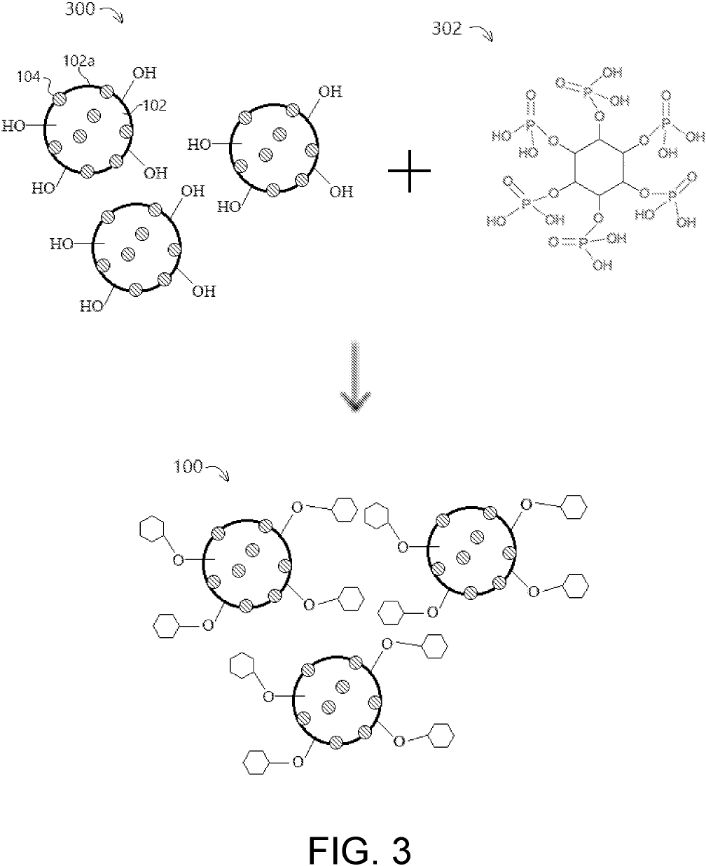

FIG. 3 is a flowchart of preparation of a modified catalyst of a phosphoric acid fuel cell according to another embodiment of the disclosure. The same reference numerals as those in the above embodiment denote the same compositions, and the content of the same compositions may be understood with reference to the description of the above embodiment and will not be repeated.

Referring to FIG. 3, a preparation process of the present embodiment includes providing a catalyst 300 as a first step. The catalyst 300 includes the particle of the metal-doped porous material of the above embodiment. The catalyst 300 may be a commercially available catalyst or a synthesized catalyst. Generally, in the commercially available catalyst, the surface 102a of the porous carrier 102 includes a relatively large number of metal microparticles 104. Then, the catalyst 300 is mixed with an acid 302 having a phosphate group. The acid 302 is a substance having a phosphate group, and the hydroxyl groups of the surface 102a of the porous carrier 102 can be subjected to a chemical conjugation reaction with acid 302. The acid 302 having a phosphate group as shown in FIG. 3 is phytic acid. However, the disclosure is not limited thereto, and examples of the acid 302 having a phosphate group include phosphoric acid, phosphonic acid and inositol tetraphosphate. In one embodiment, a temperature of the above chemical conjugation reaction is, for example, 70° C. to 110° C., and a reaction time is, for example, 2 hours to 4 hours. However, the disclosure is not limited thereto.

Conventionally, in order to prevent or reduce phosphoric acid leakage in a phosphoric acid fuel cell, efforts have been made on the membrane materials of the phosphoric acid fuel cell, or a chemical substance has been mixed into the catalyst layer of the phosphoric acid fuel cell to enhance hydrophilicity. In contrast, in the present embodiment, a substance (that is, the phosphate-containing acid group 106) capable of conducting protons is directly bonded to a surface of the catalyst 300. Accordingly, a modified catalyst having high phosphoric acid adsorption capacity can be prepared in a simple manner.

The following describes experiments carried out for verifying the effects of the disclosure. However, the disclosure is not limited to the following description.

### <Preparation Example>

The materials included 200 mg of Pt/C (commercially available catalyst, model name: Vulcan® XC-72) and 8 ml of 50% phytic acid aqueous solution.

The above materials were mixed, uniformly stirred and dispersed, followed by subjecting the resultant to a heating reaction in an oven at 70° C. for two hours. After the reaction in the oven, the resultant product was processed by washing and centrifugation to remove excess phytic acid, and then dried at 85° C. to obtain a modified catalyst of the preparation example.

### <Analysis>

By X-ray photoelectron spectroscopy (XPS) analysis, it was determined that a surface of the modified catalyst prepared as described above contained 15.5 wt% of Phosphorus (P) and 9.59 wt% of Platinum (Pt).

By inductively coupled plasma (ICP) analysis, it was determined that the modified catalyst prepared as described above contained 5.49 wt% of P and 14.16 wt% of Pt.

### <Experimental Example>

The modified catalyst prepared as described above was used as both the anode catalyst and the cathode catalyst. The anode, the cathode and a polybenzimidazole (PBI) membrane were respectively immersed in phosphoric acid and then hot-pressed to obtain a membrane electrode assembly (MEA) which was then assembled into a phosphoric acid fuel cell.

### <Comparative Example>

A phosphoric acid fuel cell was fabricated in the same manner as in the experimental example except that the commercially available catalyst, Vulcan® XC-72, was directly used as both the anode catalyst and the cathode catalyst.

The following tests were conducted respectively on the fuel cells of the experimental example and the comparative example.

### <Inductively Coupled Plasma Mass Spectrometry (ICP-MS) Test>

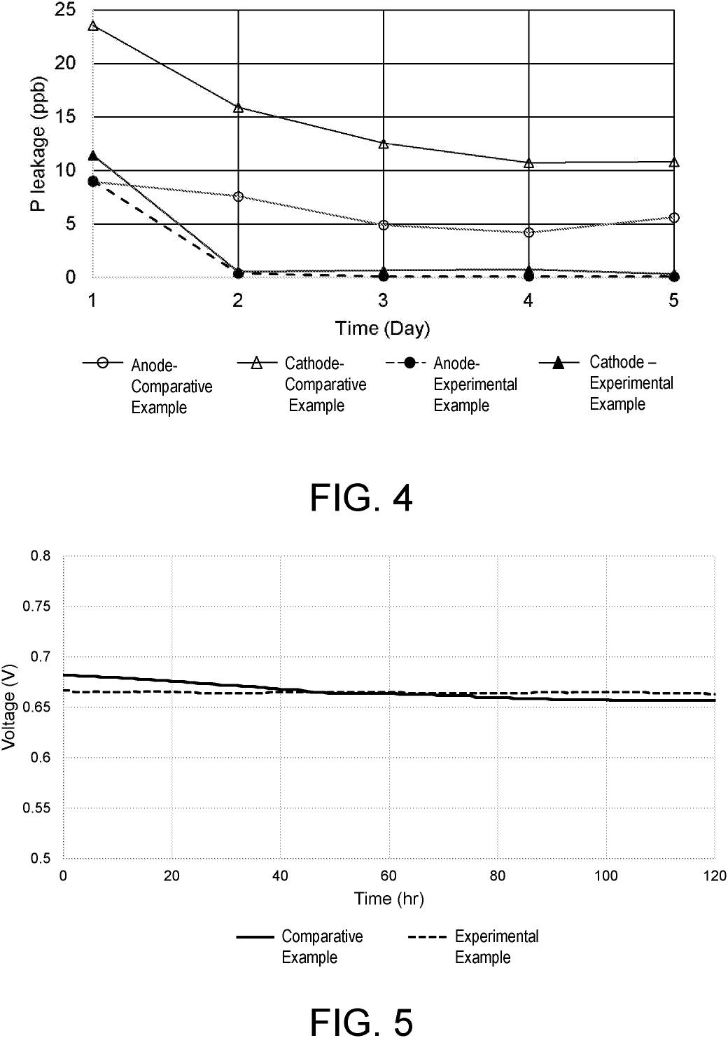

A long-term durability test was conducted on the fuel cells with the current density of the fuel cells being fixed at 0.2 A/cm², the temperature being maintained at 160° C., and 200 sccm of hydrogen and oxygen being continuously fed. During the test, the gas (containing phosphoric acid vapor) generated respectively by the cathode and anode was passed into 10 ml of deionized water. The solution was replaced every 24 hours, and the collected solution was subjected to ICP-MS analysis to assess phosphoric acid leakage. The results are shown in Table 1 below and FIG. 4. In FIG. 4, the vertical axis indicates the phosphoric acid leakage at the anode and the cathode, and the horizontal axis indicates the duration (from day 1 to day 5).

TABLE 1

| Time (day) | Comparative Example | | Time (day) | Experimental Example | |
|---|---|---|---|---|---|
| | Anode-commercial (ppb) | Cathode-commercial (ppb) | | Anode-phytic acid (ppb) | Cathode-phytic acid (ppb) |
| 1 | 8.97 | 23.58 | 1 | 9.05 | 11.42 |
| 2 | 7.59 | 15.91 | 2 | 0.41 | 0.55 |
| 3 | 4.91 | 12.55 | 3 | 0.12 | 0.67 |
| 4 | 4.23 | 10.74 | 4 | 0.12 | 0.74 |
| 5 | 5.63 | 10.83 | 5 | 0.10 | 0.34 |

As is clear from Table 1 and FIG. 4, in the fuel cell using the modified catalyst, an average phosphoric acid leakage at the anode during day 2 to day 5 was 3.35% of that of a commercial catalyst, and an average phosphoric acid leakage at the cathode during day 2 to day 5 was only 4.59% of that of the commercial catalyst. That is, the magnitude over time in the phosphoric acid leakage (concentration) of the experimental example was always less than that of the comparative example. Therefore, in the disclosure, electrolyte leakage is reduced.

### <Fuel Cell Long-term Durability Test>

A current density of the fuel cell was fixed at 0.2 A/cm², the temperature was maintained at 160° C., and 200 sccm of hydrogen and oxygen were continuously fed in to conduct a long-term durability test, and a change in fuel cell load voltage with time was observed. The results are shown in FIG. 5.

As is clear from FIG. 5, in the fuel cell of the comparative example, an average voltage decay rate was 208.33 µV/hr after the long-term durability test over 120 hours (five days); in the fuel cell of the experimental example, an average voltage decay rate was 33.33 µV/hr after the long-term durability test over 120 hours. Therefore, the modified catalyst conjugated with phytic acid of the disclosure has good long-term performance.

In summary, in the disclosure, a substance capable of conducting protons is directly conjugated to a catalyst. Accordingly, while proton conductivity of the catalyst is improved, the capacity in adsorbing phosphoric acid is enhanced for the catalyst as well. Thus, the leakage of phosphoric acid electrolyte in the fuel cell can be effectively reduced, thereby improving long-term performance and service life of the fuel cell.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A modified catalyst of a phosphoric acid fuel cell based on a particle of a metal-doped porous material, wherein the metal-doped porous material is a particle of a porous carrier with a plurality of metal microparticles and a plurality of hydroxyl groups on a surface of the porous carrier such that (i) the plurality of metal microparticles are attached to a first portion of the plurality of hydroxyl groups of the surface of the porous carrier and (ii) an amount of a phosphate-containing acid group or phosphate-containing acid groups can be bonded to a second portion of the plurality of hydroxyl groups of the surface of the porous carrier to form the modified catalyst.

2. The modified catalyst of the phosphoric acid fuel cell according to claim 1, wherein the phosphate-containing acid group comprises a phytic acid group, a phosphoric acid group, a phosphonic acid group or an inositol tetraphosphate group.

3. The modified catalyst of the phosphoric acid fuel cell according to claim 1, wherein the porous carrier comprises activated carbon, carbon black, fullerene, carbon nanotube, graphene or graphene oxide.

4. The modified catalyst of the phosphoric acid fuel cell according to claim 1, wherein a material of the metal microparticles comprises platinum, ruthenium, palladium, cobalt, iridium or nickel.

5. A phosphoric acid fuel cell comprising the modified catalyst according to claim 1.

6. A process for preparing a modified catalyst of a phosphoric acid fuel cell, wherein by providing a catalyst that is a particle of a metal-doped porous material as a precursor source, with the metal-doped porous material being a particle of a porous carrier with a plurality of metal microparticles and a plurality of hydroxyl groups on the surface of the porous carrier such that the plurality of metal microparticles are attached to a first portion of the plurality of hydroxyl groups of the surface of the porous carrier, the provided catalyst is modified by mixing with a phosphate-containing acid to subject a second portion of the plurality of hydroxyl groups of the surface of the porous carrier to a chemical conjugation reaction with the phosphate-containing acid.

7. The process for preparing the modified catalyst of the phosphoric acid fuel cell according to claim 6, wherein the phosphate-containing acid comprises phytic acid, phosphoric acid or inositol tetraphosphate.

8. The process for preparing the modified catalyst of the phosphoric acid fuel cell according to claim 6, wherein the catalyst comprises a commercially available catalyst or a synthesized catalyst.
